(19) United States
(12) Patent Application Publication
(10) Pub. No.: US 2004/0026989 A1
(43) Pub. Date: Feb. 12, 2004

(54) Electric parking brake system and method for controlling the electric parking brake system

(76) Inventors: Hidetoshi Suzuki, Hamamatsu-shi (JP); Eiji Ina, Toyohashi-shi (JP)

Correspondence Address: Douglas J. Christensen, Esq., Patterson, Thuente, Skaar & Christensen, P.A., 4800 IDS Center, 80 South Eighth Street, Minneapolis, MN, 55402-2100, US

(21) Appl. No.: 10/635,290

(22) Filed: Aug. 6, 2003

(30) Foreign Application Priority Data
Jul. 8, 2002 (JP) 2002-230218
Sep. 30, 2002 (JP) 2002-286478

(51) Int. Cl. B60T 17/16

(52) U.S. Cl. 303/89; 303/20; 188/265

(57) ABSTRACT

An electric parking brake system has an electric motor, an output shaft, a frictional member, a drive circuit and a controller. The output shaft is reciprocated by the electric motor. The output shaft presses the frictional member against a rotor of a vehicle such that the frictional member applies brake to a wheel of the vehicle with a predetermined baking force. The drive circuit supplies a voltage to the electric motor to drive the electric motor. The controller controls the drive circuit. For a predetermined period that is required for the frictional member to generate the predetermined braking force, the controller causes the drive circuit to supply a predetermined constant voltage to the electric motor.

### BACKGROUND OF THE INVENTION

The present invention relates to an electric parking brake system for vehicles, and a method for controlling the electric parking brake system.

In recent years, electric parking brake systems have been introduced. Such a brake system is operated by an actuator having an electric motor as a power source. An electric parking brake system converts rotational torque generated by an electric motor into linear torque of an output shaft with a reduction gear, thereby pressing a brake pads of a disk brake, which are connected to the output shaft, against a disc rotor, or pressing shoes of a drum brake against a drum. In this manner, the electric parking brake system generates braking force.

Japanese Laid-Open Patent Publication No. 2001-39279 discloses a method for controlling braking force. In this method, a voltage applied to or a current supplied to electric motors are finely controlled for changing the rotational torque generated by the electric motors. The braking force is controlled, accordingly.

However, in the method disclosed in Japanese Laid-Open Patent Publication No. 2001-39279, the rotational torque of the electric motors and the braking force of the parking brake system need to be directly detected. Alternatively, the braking force needs to be estimated based on the current supplied to the electric motors. This complicates the system and increases the costs. Also, when there are abrupt changes of the load on the electric motors, inertial force is generated based on the rotation of the motors. This causes the generated braking force to be unstable.

### SUMMARY OF THE INVENTION

Accordingly, it is an objective of the present invention to provide a simply constructed electric parking brake system that stably generates braking force, and to a method for controlling the electric parking brake system.

To achieve the above object, the present invention provides an electric parking brake system for a vehicle. The electric parking brake system has an actuator, a frictional member, a drive circuit and a controller. The actuator includes an electric motor and an output shaft. The output shaft is reciprocated by the electric motor. The frictional member is capable of approaching and separating from a rotor that integrally rotates with a wheel of the vehicle. The output shaft presses the frictional member against the rotor such that the frictional member applies brake to the wheel with a predetermined baking force. The drive circuit supplies a voltage to the electric motor to drive the electric motor. The controller controls the drive circuit. For a predetermined period that is required for the frictional member to generate the predetermined braking force, the controller causes the drive circuit to supply a predetermined constant voltage to the electric motor.

The present invention also provides a method for controlling an electric parking brake system for a vehicle. The electric parking brake system uses an actuator having an electric motor to press a frictional member against a rotor that rotates integrally with a wheel of the vehicle, thereby applying brake to the wheel with a predetermined braking force, the method includes controlling a drive circuit to supply a constant voltage to the electric motor for a predetermined period that is required for the frictional member to generate the predetermined braking force.

The present invention also provides another electric parking brake system for a vehicle. The electric parking brake system has an actuator, a frictional member, a drive circuit and a controller. The actuator includes an electric motor and an output shaft. The output shaft is reciprocated by the electric motor. The frictional member is capable of approaching and separating from a rotor that integrally rotates with a wheel of the vehicle. The output shaft presses the frictional member against the rotor such that the frictional member applies brake to the wheel with a predetermined baking force. The drive circuit supplies a voltage to the electric motor to drive the electric motor. The controller controls the drive circuit. The controller determines a voltage to be supplied to the electric motor based on a state of the vehicle. The controller controls the drive circuit to supply the determined voltage to the electric motor for a predetermined period.

The present invention also provides another method for controlling an electric parking brake system for a vehicle. The electric parking brake system uses an actuator having an electric motor to press a frictional member against a rotor that rotates integrally with a wheel of the vehicle, thereby applying brake to the wheel with a predetermined braking force. The method includes determining a voltage to be supplied to the electric motor based on a state of the vehicle; and controlling the drive circuit to supply the determined voltage to the electric motor for a predetermined period.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a diagrammatic view illustrating an electric parking brake system according to a first embodiment of the present invention;

FIG. 2 is a diagrammatic view illustrating a brake and a driving portion of the electric parking brake system shown in FIG. 1;

FIG. 3 is a graph showing the relationship between a power source voltage and a duty ratio of PWM;

FIG. 4 is a graph showing the relationship of a voltage supply period To the power source voltage and to a traveled distance of an output shaft;

FIG. 5 is a diagram showing the structure of the memory in the ECU;

FIG. 6 is a diagrammatic view illustrating an electric parking brake system according to a second embodiment of the present invention;

FIG. 7 is a diagrammatic view illustrating a brake and a driving portion of the electric parking brake system shown in FIG. 6;

FIG. 8 is a graph showing the relationship of the voltage supply period To the power source voltage and to the traveled distance of the output shaft according to the second embodiment;

FIG. 9 is a diagram showing the structure of the memory in the ECU according to the second embodiment; and

FIG. 10 is a graph showing the relationship between the motor temperature and a voltage adjustment.

### DETAILED DESCRIPTION OF THE PREFERRED EMBODIMENTS

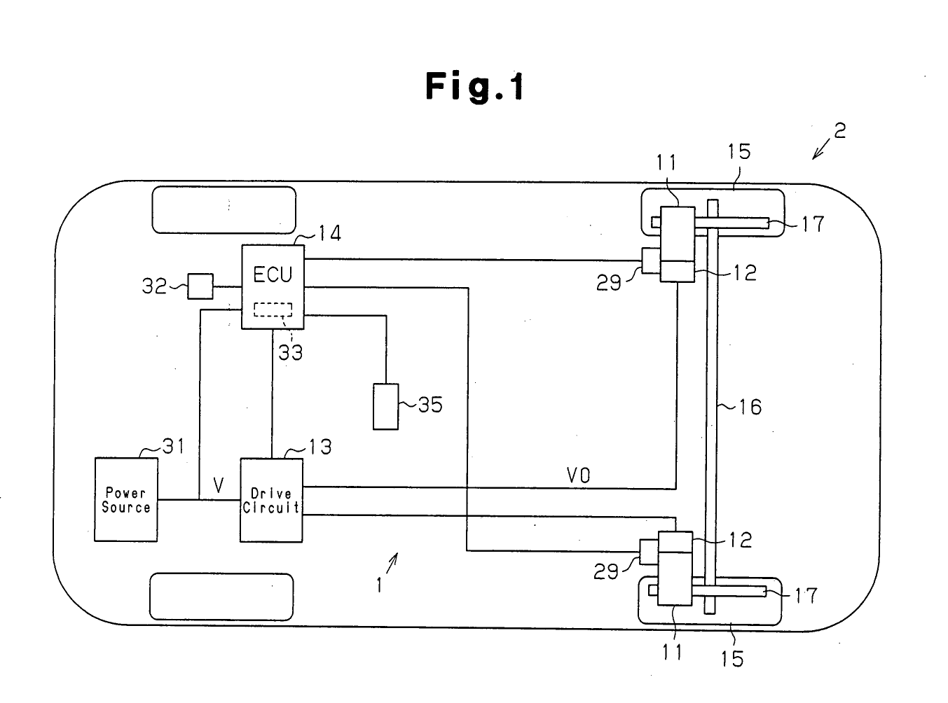

A first embodiment of the present invention will now be described with reference to FIGS. 1 to 5.

FIG. 1 is a diagrammatic view illustrating a vehicle 2 having an electric parking brake system 1. The electric parking brake system 1 is a floating caliper type disc brake system. The electric parking brake system 1 includes two braking portions 11, two actuators, a drive circuit 13 for supplying electricity to the actuators 12, and an electronic control unit (ECU) 14 connected to the drive circuit 13.

The braking portions 11 are each provided at one of the rear wheels 15. Rotors, which are discs 17 in this embodiment, are fixed to a rear axle 16. Each disc 17 corresponds to one of the braking portions 11. Each braking portion 11 is connected to one of the actuators 12, and stops rotation of or locks the corresponding disc 17 with force generated by the corresponding actuator 12.

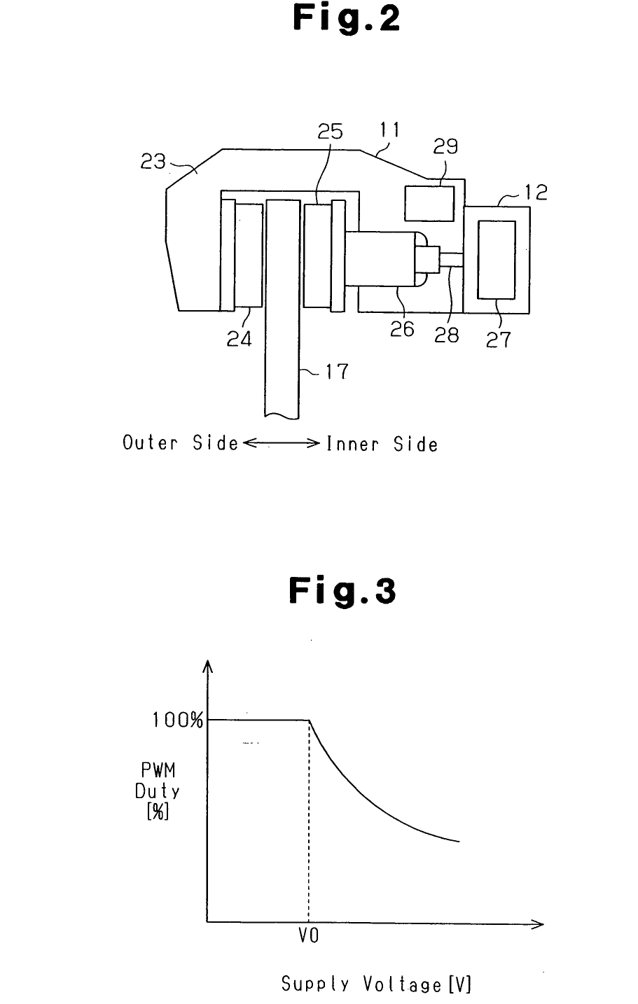

As shown in FIG. 2, each braking portion 11 includes a brake caliper 23, an outer brake pad 24, an inner brake pad 25, and a piston 26. The brake pads 24, 25 function as frictional members.

The brake caliper 23 is supported by a bracket (not shown) that rotatably supports the rear axle 16, such that the brake caliper 23 is movable in a predetermine range in the axial direction of the rear axle 16. The brake pads 24, 25 are arranged in the brake caliper 23, and face the sides (an outer side and an inner side) of the disc 17 fixed to the axle 16, respectively. Specifically, the outer brake pad 24 is located toward the outer side of the brake caliper 23, and the inner brake pad 25 is located toward the inner side of the brake caliper 23. The inner brake pad 25 is movable in a direction perpendicular to the longitudinal direction of the disc 17.

The piston 26 is located toward the inner side of the brake caliper 23 relative to the inner brake pad 25. The piston 26 reciprocates to cause the inner brake pad 25 to contact and separate from the disc 17. When the inner brake pad 25 is pressed against the disc 17, the reaction force moves the brake caliper 23 toward the inner side (rightward as viewed in FIG. 2). In accordance with the movement of the brake caliper 23, the outer brake pad 24 is pressed against the disc 17.

The actuator 12 includes an electric motor 27 and an output shaft 28. The actuator 12 is activated when electricity is supplied to the electric motor 27 from the drive circuit 13. The actuator 12 converts forward and reverse rotations of the electric motor 27 into reciprocation of the output shaft 28 with a motion converter. In this embodiment, the output shaft 28 is directly coupled to the piston 26. When the electric motor 27 of the actuator 12 rotates and the output shaft 28 reciprocates, the piston 26 is driven by the actuator 12. In accordance with the reciprocation of the piston 26, the brake pads 24, 25 contact and separate from the disc 17.

A distance sensor 29 is located in the vicinity of the output shaft 28. The distance sensor 29 detects a traveled distance of the output shaft 28 during operation of the actuator 12, and sends a detection signal to the ECU 14.

Referring to FIG. 1, the drive circuit 13 receives commands from the ECU 14 and transforms a supply voltage V of an on-vehicle electric power source 31 to a predetermined voltage V0. The drive circuit 13 supplies the predetermined voltage V0 to the electric motors 27 of the actuators 12. The voltage V is transformed to the predetermined voltage V0 through the PWM control. The ECU 14 monitors the power supply voltage V of the electric power source 31. When the power supply voltage V exceeds the predetermined voltage V0, the ECU 14 commands the drive circuit 13 to lower the duty ratio.

When the power supply voltage V is less than the predetermined voltage V0, the ECU 14 commands the rive circuit 13 to increase the duty ratio to 100% (see FIG. 3). At this time, the ECU 14 turns a warning lamp 32 (see FIG. 1) to warn occupants of the vehicle 2 that the electric power source 31 is about to be exhausted. The warning lamp 32 is located in a passenger compartment (not shown) and functions as warning means.

The ECU 14 includes storing means, which is a memory 33. In addition to the predetermined voltage V0, the memory 33 stores data necessary for controlling the drive circuit 13. An inclination sensor 35 is connected to the ECU 14. The inclination sensor 35 detects the gradient of the road surface on which the vehicle 2 is located, that is, the inclination angle θx of the vehicle 2, and sends a detection signal to the ECU 14.

The operation of the electric parking brake system 1 will now be described.

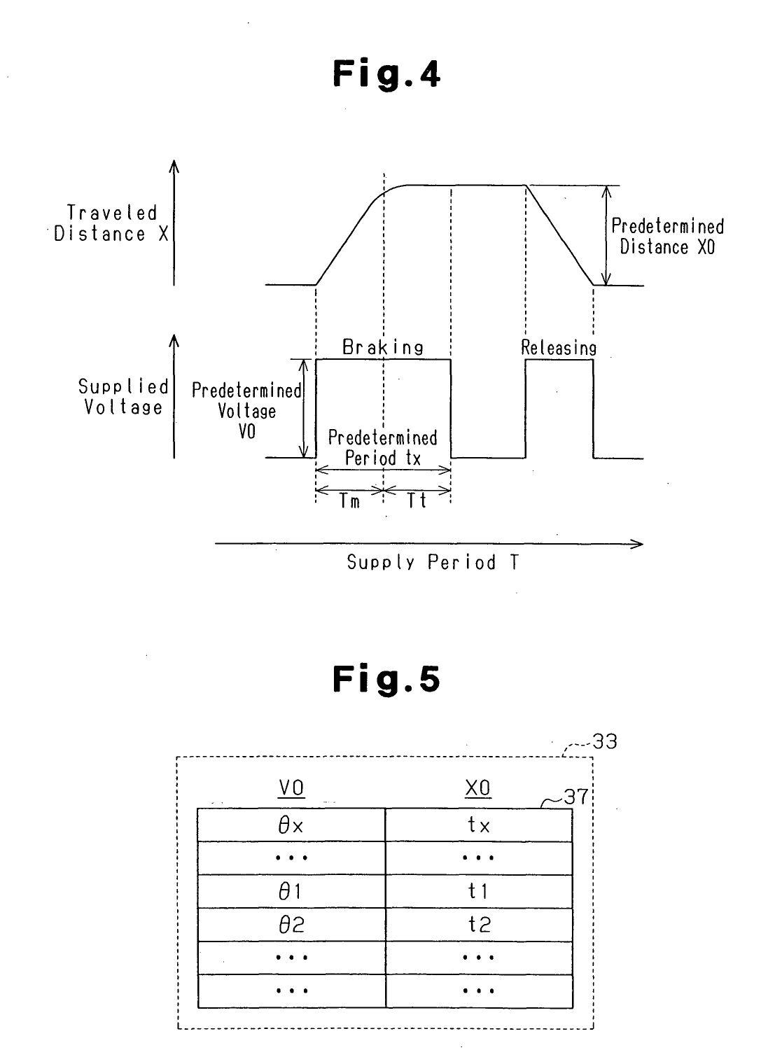

Referring to FIG. 4, a supply period T during which the predetermined voltage V0 is supplied to the actuator 12 is varied for generating a braking force sufficient for preventing the vehicle 2 from moving.

Specifically, when the vehicle 2 needs to be prevented from moving, the ECU 14 commands the drive circuit 13 to supply the predetermined voltage V0 to the electric motor 27 of each actuator 12 during a predetermined period tx, which is sufficient for stopping the vehicle 2. The actuator 12 converts rotation of the electric motor 27 into linear motion of the output shaft 28 during the predetermined period tx, so that the piston 26 coupled to the output shaft 28 is moved. In accordance with the motion of the piston 26, the corresponding brake pads 24, 25 are moved toward and pressed against the disc 17. Accordingly, the vehicle 2 is prevented from moving.

During a period until the brake pads 24, 25 contacts the disc 17, that is, a period Tm from when the ECU 14 outputs a braking command to when the brake starts being applied (idle running period), the electric motor 27 receives a relatively low load. In this state, the voltage supplied to the electric motor 27 is constant. Therefore, drive torque generated by rotation of the electric motor 27 is substantially entirely used for moving the output shaft 28, or for moving the brake pads 24, 25. The traveled distance X of the output shaft 28 is proportional to the idle running period Tm. For given distances between each disc 17 and the corresponding brake pads 24, 25, the idle running period Tm is constant.

After the brake pads 24, 25 contact the disc 17, the drive torque of the electric motor 27 is substantially entirely converted into a force for pressing the brake pads 24, 25 against the disc 17. That is, the drive torque is converted into braking torque. The braking force generated by the electric parking brake system 1 is increased in proportion to the duration of a pressing period Tt. The braking force generated by the electric parking brake system 1 is changed in accordance with the predetermined period tx (the sum of the idle running period Tm and the pressing period Tt).

As shown in FIG. 5, in addition to the predetermined voltage V0, the memory 33 of the ECU 14 stores a control table 37. The control table 37 defines the predetermined period tx for generating a sufficient braking force for preventing the vehicle 2 from moving. The predetermined period tx includes a plurality of data periods (t1, t2). The inclination angle Ox includes a plurality of inclination angle data (θ1, θ2). Each data period corresponds to one of the inclination angle data.

Based on the detection signal related to the inclination angle θx of the vehicle 2 sent from the inclination sensor 35, the ECU 14 commands the drive circuit 13 to supply the predetermined voltage V0 to the electric motors 27 during the predetermined period tx.

For example, if an inclination data θ1 is sent from the inclination sensor 35, the ECU 14 commands the drive circuit 13 to supply the predetermined voltage V0 to the electric motor 27 during a first data period t1. If an inclination data θ2 is sent from the inclination sensor 35, the ECU 14 commands the drive circuit 13 to supply the predetermined voltage V0 to the electric motors 27 during a second data period t2. The data periods T0 are stored in the control table 37 and each correspond to one of the inclination angles θx. The data periods T0 are obtained through experiments in advance.

When the power supply voltage V is less than the predetermined voltage V0, the ECU 14 sets the duty ratio to 100% as described above. Then, the ECU 14 commands the drive circuit 13 to supply the predetermined voltage V0 to the electric motors 27 for a predetermined period Tx.

An operation for releasing the parking brake will now be described. The ECU 14 commands the drive circuit 13 to supply a voltage that is opposite the voltage for applying brake to the electric motors 27. Each electric motor 27 rotates in a reverse direction in relation to rotation for applying brake. Accordingly, the output shaft 28 is moved with the piston 26 in a direction for separating the brake pads 24, 25 from the discs 17. Accordingly, the parking brake is released.

When the parking brake is released, the ECU 14 monitors the traveled distance X of the output shafts 28, which is sent from the distance sensors 29. When the traveled distance X reaches a predetermined distance X0 (see FIG. 4), the ECU 14 commands the drive circuit 13 to stop supplying voltage to the electric motor 27. That is, the control for releasing the parking brake is executed by moving the output shafts 28 by the predetermined distance X0 (see FIG. 5), which is previously stored in the memory 33, in a direction for moving the brake pads 24, 25 away from the discs 17.

This embodiment provides the following advantages.

In response to commands from the ECU 14, the drive circuit 13 supplies the predetermined voltage V0, which is generated by transforming the power supply voltage V of the electric power source 31, to the electric motors 27 of the actuators 12. Accordingly, the electric motors 27 receive a constant voltage. This stabilizes the drive torque of the electric motors 27. As a result, a stable braking force is generated. Since the predetermined voltage V0 is supplied to the electric motors 27, motion converters of the actuators 12 do not receive excessive load. This lowers the level of required strength of the motion converters.

The braking force is controlled by changing the supply period T, during which the predetermined voltage V0 is supplied to the actuators 12. In this embodiment, no torque sensors are needed for controlling the braking force. This simplifies the configuration.

Each distance sensor 29 detects the amount of movement (traveled distance) of the corresponding output shaft 28 during operation of the actuator 12, and sends a detection signal to the ECU 14. While releasing the parking brake, the ECU 14 monitors the traveled distance X of each output shaft 28. When the traveled distance X reaches the predetermined distance X0, the ECU 14 commands the drive circuit 13 to stop supplying voltage to the electric motors 27. Accordingly, when the parking brake is released, the distance between each of the brake pads 24, 25 and the corresponding disc 17 is always the same. Therefore, the idle running period Tm for the subsequent application of the parking brake will be the same as that of the current braking. In other words, a stable braking force is always generated. Further, the power that the electric motor 27 is required to generate is reduced.

When receiving an inclination data θx, which indicates that the road surface on which the vehicle 2 stays is inclined, from the inclination sensor 35, the ECU 14 commands the drive circuit 13 to supply the predetermined voltage V0 to the electric motors 27 during the predetermined time tx that corresponds to the inclination angle θx. As a result, a braking force required for preventing the vehicle 2 from moving is generated in accordance with the condition of the road surface by a simple configuration.

When the power supply voltage V is less than the predetermined voltage V0, the ECU 14 sets the duty ratio to 100%. After the value of the voltage reaches the predetermined voltage V0, the ECU 14 commands the drive circuit 13 to supply the predetermined voltage V0 to the motors 27 for the predetermined period tx. As a result, even if the voltage of the electric power source 31 is low, a stable braking force is generated.

When the power supply voltage V is less than the predetermined voltage V0, the warning lamp 32 in the passenger compartment (not shown) is lit. Accordingly, occupants of the vehicle 2 is warned of the low voltage of the electric power source 31.

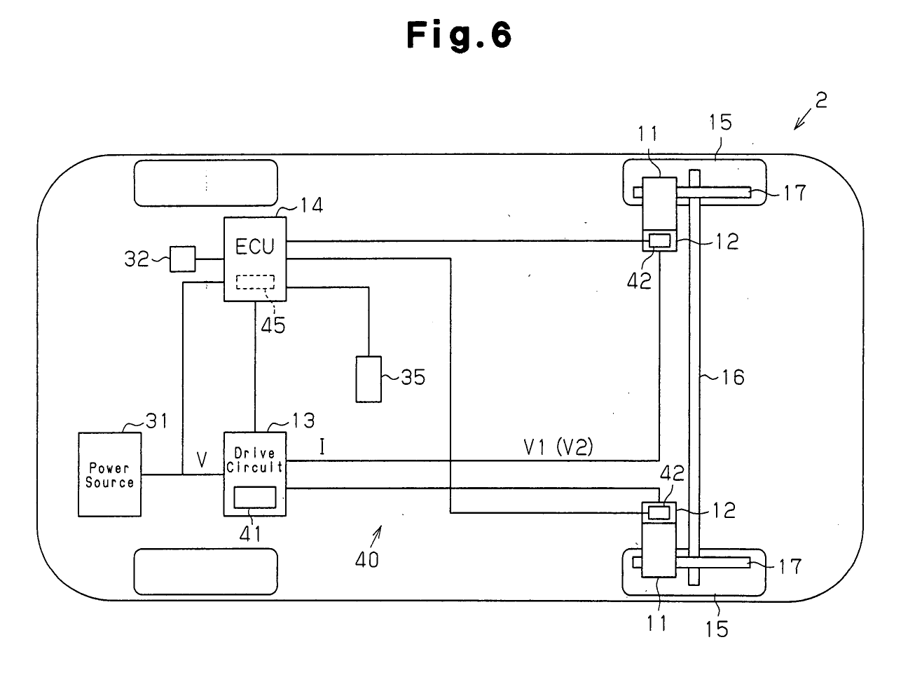

A second embodiment of the present invention will now be described with reference to FIGS. 6 and 10. The differences from the embodiment of FIGS. 1 to 5 will mainly be discussed. Like or the same reference numerals are given to those components that are like or the same as the corresponding components of the embodiment of FIGS. 1 to 5 and detailed explanations are omitted.

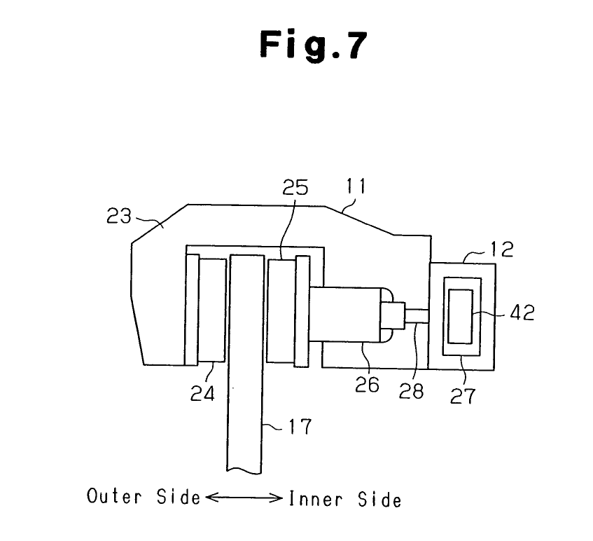

As shown in FIG. 6, a drive circuit 13 of an electric parking brake system 40 includes an electric current sensor 41. Instead of the distance sensor 29, each actuator 12 has a pulse generator 42. The current sensor 41 detects a current I supplied to the electric motors 27, and sends the detected value to the ECU 14. The pulse generator 42 of each actuator 12 is provided at a rotation shaft (not shown) of the corresponding electric motor 27, and generates pulses according to rotational state of the electric motor 27 (see FIG. 7). The pulse generators 42 are connected to the ECU 14, which functions as controlling means. The ECU 14 monitors pulses generated by the pulse generators 42. Each pulse generator 42 includes a ring magnet and a Hall IC.

The operation of the electric parking brake system 40 will now be described.

A control of braking force generated by the electric parking brake system 40 of this embodiment includes two stages, or initial braking and re-pressing. After the initial braking, the re-pressing is performed for compensating for influences of the temperature of the electric motors 27. Specifically, due to a temperature raise, the torque of the electric motors 27 is lowered, which reduces the braking force. When applying the parking brake, the ECU 14 first supplies a first voltage V1 to the electric motors 27 for a first period T1. Then, to compensate for the reduced braking force, the ECU 14 supplies a second voltage V2 to the motors 27 for a second period T2.

For example, even if the voltage supplied to the electric motors 27 is constant, when the temperature of the motor 27 is high, the resistance of the coils in the motors 27 is increased, and the magnetization of the magnets in the motors 27 is lowered. Accordingly, the torque generated by each electric motor 27 is deceased compared to that in a reference temperature, which is an ordinary temperature. For example, if the temperature coefficient of resistance α is 0.4%, and the temperature coefficient β of the magnets is −0.2%, the torque generated by the electric motor 27 is calculated to be lowered to 71% of the ordinary temperature when the temperature of the motor 27 increased from 20° C. (ordinary temperature) to 80° C. As the torque generated by the electric motors 27 is reduced, the braking force generated by the electric parking brake system 40 is reduced. Therefore, after the initial braking in which the first voltage V1 is supplied to the electric motors 27 for the first period T1, the re-pressing is performed by supplying the second voltage V2 to the electric motors 27 for the second period T2. Accordingly, the decrease in the braking force due to the temperature raise of the electric motors 27 is compensated for.

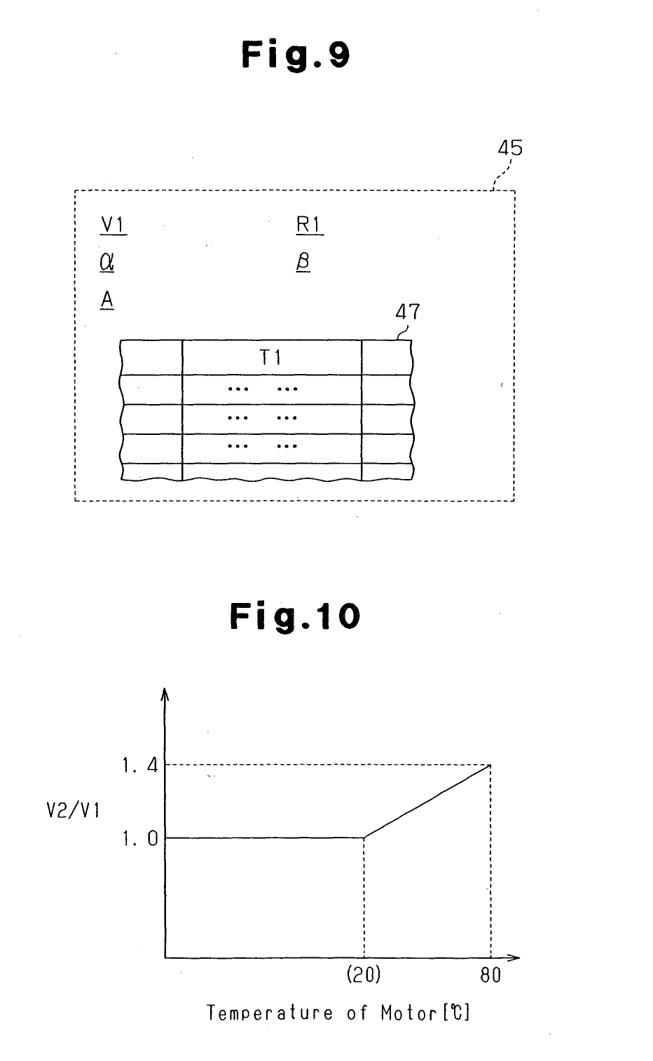

As shown in FIG. 9, a memory 45 of the ECU 14 stores a control table 47. In addition to the first voltage V1, the control table 47 stores the initial braking period T1. The ECU 14 supplies current to the electric motors 27 based on the control table 47.

Specifically, when applying the parking brake, the ECU 14 commands the drive circuit 13 to supply the first voltage V1 to the electric motor 27 of the actuator 12 during the initial braking period T1. The actuator 12 converts rotation of the electric motor 27 into linear motion of the output shaft 28 during the initial braking period T1, so that the piston 26 coupled to the output shaft 28 is moved. Subsequently, the brake pads 24,25 are moved toward, and pressed against the disc 17.

The ECU 14 detects pulses generated by the pulse generators 42. When pulse changes disappear, the ECU 14 determines that the motors 27 are in lockup state, and sets the current I from the current sensor 41 at the time as a lockup current It. The ECU 14 estimates the temperature of the electric motor 27 based on the lockup current It and determines the second voltage V2, which is supplied in the re-pressing.

Specifically, during the initial braking, the current I supplied to the electric motors 27 is lowered as the load on the motors 27 decreases when the motors 27 are started. Thereafter, the current I is substantially constant until the brake pads 24, 25 contacts the disc 17, or during the idle running period. As the load is increased by pressing the brake pads 24, 25 against the disc 17, the current I starts increasing. When the brake pads 24, 25 cannot be moved further, the current I converges to a certain value. At this time, the electric motor 27 does not rotate, and the changes of the pulses generated by the pulse generator 42 is therefore zero. In this state, the ECU 14 determines that the motor 27 is locked up, and sets the current I of this state as the lockup current It.

Thereafter, the ECU 14 computes the temperature of the electric motors 27 based on the lockup current It. Specifically, the ECU 14 computes an operational resistance R2 of the electric motor 27 based on the lockup current It and the first voltage V1. Further, the ECU 14 computes the rate of increase of the resistance by comparing the operational resistance R2 with an ordinary temperature resistance R1 (see FIG. 9). The ordinary temperature resistance R1 is previously stored in the memory 45 and used as a reference resistance. Based on the rate of increase of the resistance and the temperature coefficient of resistance α, the ECU 14 computes the temperature of the electric motors 27.

For example, suppose that the ordinary temperature resistance is 1Ω, the first voltage V1 is 8V, and the lockup current It is 6.45 A. In this case, since the operational resistance R2 is 1.24Ω, the rate of increase of the resistance of the electric motor 27 ((R2−R1)/R1) is 0.24. A value (60) obtained by dividing 0.24 by the temperature coefficient of resistance a (0.4) is added to the ordinary temperature (20). Accordingly, the temperature of the electric motor 27 during operation is computed as 80° C.

Then, the ECU 14 determines the value of the second voltage V2 supplied in a re-pressing for compensating for influences of the temperature. During the second period T2, which is the re-pressing period, the ECU 14 commands the drive circuit 13 to supply the second voltage V2 to the electric motors 27 of the actuators 12. The influence of the temperature of the electric motors 27 is estimated based on the temperature coefficient of resistance α and the temperature coefficient β of the magnets, which are stored in the memory 45. The influence of the temperature of the electric motors 27 is represented by the ratio of torque generated by the electric motors 27 in an ordinary temperature to the torque generated by the electric motors 27 during operation. The second voltage V2 is computed by multiplying the reciprocal of the estimated influence of the temperature of the electric motors 27 by the first voltage V1 (see FIG. 10). For example, when the first voltage V1 is 8V during the initial braking, and the temperature of the electric motors 27 during operation is 80° C., the torque generated by each electric motor 27 is 71% of that in an ordinary temperature. That is, the influence of the temperature of the electric motors 27 is 0.71/1. In this case, the second voltage V2 is computed by multiplying the first voltage V1 (8V) of the initial braking by the reciprocal of the influence of the temperature (1/0.71). The second voltage V2 is thus 11.2 V.

The voltage supplied to the electric motors 27 is transformed through the PWM control. The drive circuit 13 receives the PWM duty ratio from the ECU 14, and transforms the power supply voltage V to the first and second voltages V1, V2 and supplies the voltages V1, V2 to the electric motors 27 of the actuators 12. For example, if the first voltage V1 of the initial braking is 8V, and the power supply voltage V is 12V, the ECU 14 commands the drive circuit 13 to set the PWM duty ratio to 66.7% during the initial braking, and commands the drive circuit 13 to set the PWM duty ratio to 93.3% during the re-pressing. Based on commands from the ECU 14, the drive circuits 13 supply the second voltage V2 to the electric motors 27 during the second period T2, thereby performing the re-pressing. Accordingly, the braking is completed. In this embodiment, the second period is determined by multiplying the first period T1 by a predetermined coefficient. The second period T2 is proportionate to the first period T1 and corresponds to the temperature of the electric motor 27.

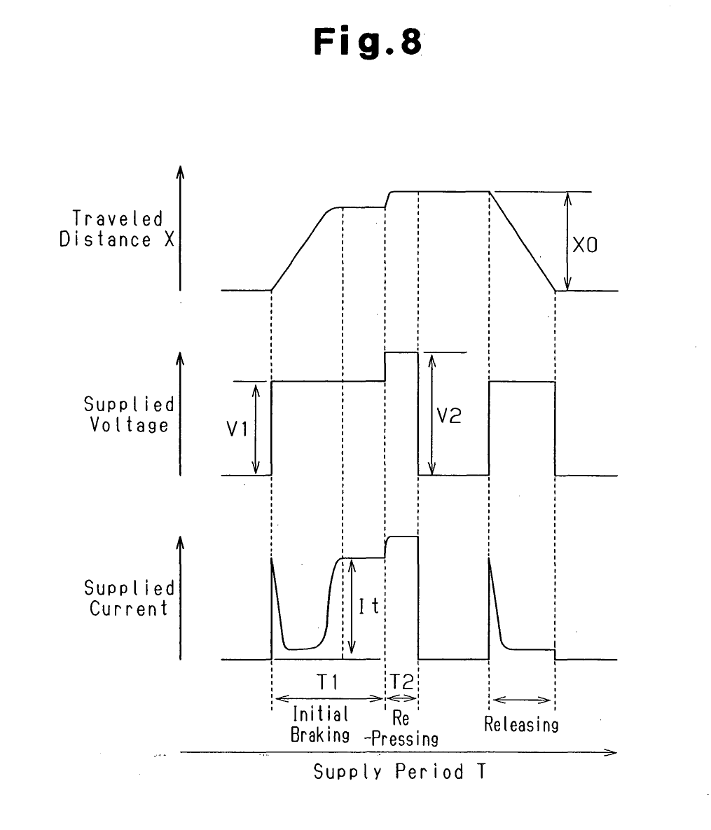

An operation for releasing the parking brake will now be described. The ECU 14 commands the drive circuit 13 to supply a voltage that is opposite the voltage for applying the parking brake, or the first voltage V1 in this embodiment (see FIG. 8), to the electric motor 27. Accordingly, the parking brake is released.

Specifically, when releasing the parking brake, the ECU 14 monitors pulses generated by the pulse generators 42 provided at the rotation shafts (not shown) of the electric motors 27. At this time, since the load on the motors 27 is low, the torque generated by rotation of each motor 27 is substantially entirely used for moving the corresponding output shaft 28, that is, for moving the brake pads 24, 25. The traveled distance X of the output shafts 28 is proportionate to the number of rotation of the electric motors 27. Therefore, by monitoring the pulses generated by the pulse generators 42, the ECU 14 obtains the traveled distance X of the output shafts 28. When the count value of the pulses reaches a predetermined count value A previously stored in the memory 45, the ECU 14 determines that the traveled distance X of the output shafts 28 is a predetermined distance X0, and commands the drive circuit 13 to stop supplying current to the electric motors 27. As a result, the release of the parking brake is completed.

This embodiment provides the following advantages.

The braking force generated by the electric parking brake system 40 is controlled in the following manner. First, the first voltage V1 is supplied to the electric motors 27 for the first period T1. Then, to compensate for a decrease of the braking force due to a decrease of the torque of the motors 27 caused by temperature changes, the second voltage V2 is supplied to the electric motors 27 for the second period T2.

The voltage supplied to the electric motors 27 is adjusted based on the temperature of the electric motors 27. Therefore, even if the temperature of the electric motors 27 changes, a stable motor torque and a stable braking torque are generated.

The ECU 14 monitors pulses generated by the pulse generators 42. When there is no changes in pulses, the ECU 14 determines that the electric motors 27 are in the lockup state and estimates the temperature of the electric motors 27 based on the lockup current It, thereby determining the predetermined voltage V2 to be supplied during re-pressing.

Accordingly, the temperature of the electric motors 27 is estimated without providing temperature sensors. In other words, the temperature of the electric motors 27 is detected with a simple configuration.

The second voltage V2 is determined by multiplying the reciprocal of the ratio of the generated torque of the electric motors 27 in an ordinary temperature to the generated torque of the electric motors 27 during operation by the first voltage V1. Therefore, during re-pressing, the second voltage V2 corresponding to the temperature of the electric motors 27 is supplied to the electric motors 27. As a result, stable braking force is generated.

The ECU 14 releases the parking brake in the following manner. That is, when the count value of the pulses generated by the pulse generators 42 reaches a predetermined count value previously stored in the memory 45, the ECU 14 determines that the traveled distance X of the output shafts 28 is a predetermined distance X0, and commands the drive circuit 13 to stop supplying current.

Accordingly, the traveled distance of the output shafts 28 is computed without additionally providing traveled distance sensors. Thus, the traveled distance of the output shafts 28 is detected with a simple configuration. Also, the positions of the brake pads 24, 25 are stabilized when the parking brake is released. This minimizes the idle running distance in the subsequent application of the parking brake. As a result, time required for applying the parking brake is shortened and stabilized. This minimizes the required output of the electric motors 27.

It should be apparent to those skilled in the art that the present invention may be embodied in many other specific forms without departing from the spirit or scope of the invention. Particularly, it should be understood that the invention may be embodied in the following forms.

In the embodiments of FIGS. 1 to 10, the electric parking brake systems 1, 40 may be of a fixed caliper type. Also, drum brakes may be used instead of the disk brakes.

In the embodiments of FIGS. 1 to 10, the braking portions 11 may be provided for the front wheels of the vehicle 2.

In the embodiments of FIGS. 1 to 10, the actuators 12 and the braking portions 11 may be located elsewhere, and the output shaft 28 of each actuator 12 may be coupled to the piston 26 of the corresponding braking portion 11 with a wire or a hydraulic pipe.

In the embodiment of FIGS. 1 to 5, the distance sensors 29 may detect the moved amount of the pistons 26 or of the brake pads 24, 25.

In the embodiment of FIGS. 1 to 5, the ECU 14 may have a sensor for monitoring the amount of depression of the foot brake, and the supply period T may be determined based on a control table corresponding to the depression amount of the foot brake.

In the embodiments of FIGS. 1 to 10, the braking portions 11 may include the foot brake and the electric parking brake 1. Alternatively, the foot brake and the electric parking brake 1 may be independent from each other.

In the embodiments of FIGS. 1 to 10, when the power supply voltage V is less than the predetermined voltage V0, a voice guidance or a warning sound may be produced with a speaker.

In the embodiments of FIGS. 1 to 10, the drive circuit 13 may be replaced by other types of voltage control means for motor.

In the embodiments of FIGS. 1 to 10, the memory 33 (the memory 45) may store the predetermined period tx (the first period T1), and the control table 37 (the control table 47) may store the predetermined voltage V0 (the first voltage V1). That is, the braking force generated by the electric parking brake system 1 (the electric parking brake system 40) may be controlled by setting the voltage supplied to the electric motors 27 to the predetermined voltage V0 (the first voltage V1), and supplying the voltage for the predetermined period tx (the first period T1), as circumstances demand.

In the embodiment of FIGS. 6 to 10, a temperature sensor may be provided in each electric motor 27, and the voltage supplied to the electric motors 27 may be adjusted based on the detection result of the temperature sensors.

In the embodiment of FIGS. 6 to 10, the control table 47 stores the first period T1, which is the initial braking period corresponding to the state of the vehicle 2. However, the control table 47 may store the second period T2. The control of the initial braking may be performed by supplying the first voltage V1 to the electric motors 27 for the first period T1 regardless of the state of the vehicle 2. The second voltage V2 may be supplied to the electric motors 27 for the second period T2 after there are no changes in the pulses generated by the pulse generators 42, that is, after the electric motors 27 are locked up.

In the embodiments of FIGS. 1 to 10, the predetermined voltage V0 (the first voltage V1) and the predetermined period tx (the first period T1) may be stored in the control table 37 (the control table 47), and the ECU 14 may determine the predetermined voltage V0 (the first voltage V1) and the predetermined period tx (the first period T1) based on the state of the vehicle.

In the embodiments of FIGS. 6 to 10, the temperature of the electric motors 27 may be detected prior to applying the parking brake, and the voltage to be supplied may be adjusted in advance for compensating for the influence of the temperature.

In the embodiment of FIGS. 6 to 10, the predetermined voltage may also be controlled not only when the temperature of the electric motors 27 is higher than the ordinary temperature, but also when the temperature of the electric motors 27 is less than the ordinary temperature.

In the embodiment of FIGS. 6 to 10, the current sensor 41 in the drive circuit 13 may be replaced by a shunt resistor for detecting the current I supplied to the electric motors 27.

In the embodiment of FIGS. 6 to 10, a table storing the second voltage V2 for re-pressing that has been obtained through experiments in advance may be used.

The present examples and embodiments are to be considered as illustrative and not restrictive and the invention is not to be limited to the details given herein, but may be modified within the scope and equivalence of the appended claims.

1. An electric parking brake system for a vehicle, comprising:
an actuator, which includes an electric motor and an output shaft, wherein the output shaft is reciprocated by the electric motor;
a frictional member, which is capable of approaching and separating from a rotor that integrally rotates with a wheel of the vehicle, wherein the output shaft presses the frictional member against the rotor such that the frictional member applies brake to the wheel with a predetermined baking force;
a drive circuit, which supplies a voltage to the electric motor to drive the electric motor; and
a controller for controlling the drive circuit, wherein, for a predetermined period that is required for the frictional member to generate the predetermined braking force, the controller causes the drive circuit to supply a predetermined constant voltage to the electric motor.

2. The electric parking brake system according to claim 1, wherein the controller determines the predetermined period based on a state of the vehicle.

3. The electric parking brake system according to claim 2, wherein the state of the vehicle includes an inclination angle of the vehicle.

4. The electric parking brake system according to claim 3, further comprising an inclination angle sensor for detecting the inclination angle of the vehicle, and a memory storing data that defines a relationship between the inclination angle of the vehicle and a period for applying a voltage to the electric motor, wherein, based on the data stored in the memory, the controller selects the voltage applying period that corresponds to the inclination angle detected by the inclination angle sensor, and sets the selected voltage applying period as the predetermined period.

5. The electric parking brake system according to claim 1, further comprising a distance sensor for detecting the traveled distance of the output shaft, wherein the controller causes the drive circuit to supply a voltage to the electric motor such that the frictional member, which is pressed against the rotor, separates from the rotor, and wherein, when the frictional member has moved away from the rotor by a predetermined distance, the controller causes the drive circuit to stop supplying the voltage to the electric motor, so that the frictional member stops applying brake.

6. The electric parking brake system according to claim 1, further comprising a pulse generator that generates pulses in accordance with rotation of the electric motor, wherein, to move the frictional member, which is pressed against the rotor, away from the rotor, the controller causes the drive circuit to apply a constant voltage that is opposite from the constant voltage for applying brake to the electric motor until the number of pulses generated by the pulse generator reaches a predetermined number, so that the frictional member stops applying brake.

7. The electric parking brake system according to claim 1, wherein the vehicle has an electric power source, and wherein the controller causes the drive circuit to perform a PWM control such that the voltage of the electric power source is converted into the constant voltage.

8. The electric parking brake system according to claim 7, wherein, when the voltage of the electric power source is less than the constant voltage, the controller sets the duty ratio in the PWM control to 100%, and determines the predetermined period based on the value of a voltage obtained according to the duty ratio of 100%.

9. The electric parking brake system according to claim 7, further comprising a warning device for warning an occupant of the vehicle, wherein, when the voltage of the electric power source is less than the constant voltage, the controller activates the warning device.

10. The electric parking brake system according to claim 1, wherein the predetermined period is a first predetermined period, and wherein, after the first predetermined period has elapsed, the controller causes the drive circuit to supply a re-pressing voltage, which is determined based on a temperature of the electric motor, to the electric motor for a second predetermined period.

11. The electric parking brake system according to claim 10, wherein the controller estimates a torque generated by the electric motor under the current temperature, and multiplies the constant voltage by the reciprocal of the ratio of the estimated torque to a referential torque that is generated by the electric motor under a predetermined referential temperature, and wherein the controller sets the resultant of the multiplication as the re-pressing voltage.

12. The electric parking brake system according to claim 10, further comprising:
a current sensor for detecting a value of a current supplied to the electric motor; and
a pulse generator that generates pulses in accordance with rotation of the electric motor;
wherein the controller computes a resistance of the electric motor based on the current value at the time when the pulses stop changing, and wherein the controller estimates the temperature of the electric motor based on the ratio of the computed resistance to a previously stored referential resistance of the electric motor.

13. A method for controlling an electric parking brake system for a vehicle, wherein the electric parking brake system uses an actuator having an electric motor to press a frictional member against a rotor that rotates integrally with a wheel of the vehicle, thereby applying brake to the wheel with a predetermined braking force, the method comprising:
controlling a drive circuit to supply a constant voltage to the electric motor for a predetermined period that is required for the frictional member to generate the predetermined braking force.

14. The control method according to claim 13, further determining the predetermined period based on a state of the vehicle.

15. The control method according to claim 14, wherein the state of the vehicle includes an inclination angle of the vehicle.

16. The control method according to claim 15, further comprising:
detecting the inclination angle of the vehicle;
storing data that defines a relationship between the inclination angle of the vehicle and a period for applying a voltage to the electric motor;
selecting the voltage applying period that corresponds to the detected inclination angle based on the data; and
setting the selected voltage applying period as the predetermined period.

17. The control method according to claim 13, further comprising:
detecting the traveled distance of the output shaft;
causing the drive circuit to supply a voltage to the electric motor such that the frictional member, which is pressed against the rotor, separates from the rotor; and
causing the drive circuit to stop supplying the voltage to the electric motor when the frictional member has moved away from the rotor by a predetermined distance, so that the frictional member stops applying brake.

18. The control method according to claim 13, further comprising:
causing a pulse generator to generate pulses in accordance with rotation of the electric motor;
causing the drive circuit to apply a constant voltage that is opposite from the constant voltage for applying brake to the electric motor until the number of the pulses generated by the pulse generator reaches a predetermined number, thereby moving the frictional member, which is pressed against the rotor, away from the rotor, so that the frictional member stops applying brake.

19. The control method according to claim 13, wherein the vehicle has an electric power source, and the control method further comprising causing the drive circuit to perform a PWM control such that the voltage of the electric power source is converted into the constant voltage.

20. The control method according to claim 19, further comprising:
setting the duty ratio in the PWM control to 100% when the voltage of the electric power source is less than the constant voltage; and
determining the predetermined period based on the value of a voltage obtained according to the duty ratio of 100%.

21. The control method according to claim 13, wherein the predetermined period is a first predetermined period, and wherein the control method further comprising causing the drive circuit to supply a re-pressing voltage, which is determined based on a temperature of the electric motor, to the electric motor for a second predetermined period after the first predetermined period has elapsed.

22. The control method according to claim 21, further comprising:
estimating a torque generated by the electric motor under the current temperature; and
multiplying the constant voltage by the reciprocal of the ratio of the estimated torque to a referential torque that is generated by the electric motor under a predetermined referential temperature, and setting the resultant of the multiplication as the re-pressing voltage.

23. The control method according to claim 21, further comprising:
detecting a value of a current supplied to the electric motor;
causing a pulse generator to generate pulses in accordance with rotation of the electric motor;
computing a resistance of the electric motor based on the current value at the time when the pulses stop changing; and
estimating the temperature of the electric motor based on the ratio of the computed resistance to a previously stored referential resistance of the electric motor.

24. An electric parking brake system for a vehicle, comprising:
an actuator, which includes an electric motor and an output shaft, wherein the output shaft is reciprocated by the electric motor;
a frictional member, which is capable of approaching and separating from a rotor that integrally rotates with a wheel of the vehicle, wherein the output shaft presses the frictional member against the rotor such that the frictional member applies brake to the wheel with a predetermined baking force;
a drive circuit, which supplies a voltage to the electric motor to drive the electric motor; and
a controller for controlling the drive circuit, wherein the controller determines a voltage to be supplied to the electric motor based on a state of the vehicle, and wherein the controller controls the drive circuit to supply the determined voltage to the electric motor for a predetermined period.

25. A method for controlling an electric parking brake system for a vehicle, wherein the electric parking brake system uses an actuator having an electric motor to press a frictional member against a rotor that rotates integrally with a wheel of the vehicle, thereby applying brake to the wheel with a predetermined braking force, the method comprising:
determining a voltage to be supplied to the electric motor based on a state of the vehicle; and
controlling the drive circuit to supply the determined voltage to the electric motor for a predetermined period.
